(19) United States
(12) Patent Application Publication
(10) Pub. No.: US 2025/0038847 A1
(43) Pub. Date: Jan. 30, 2025

(54) OPTICAL TRANSMISSION SYSTEM AND METHOD FOR CONTROLLING OPTICAL TRANSMISSION SYSTEM

(71) Applicant: NEC Corporation, Minato-ku, Tokyo (JP)

(72) Inventors: Keiichi Matsumoto, Tokyo (JP); Kohei Hosokawa, Tokyo (JP)

(73) Assignee: NEC Corporation, Minato-ku, Tokyo (JP)

(21) Appl. No.: 18/711,149

(22) PCT Filed: Dec. 7, 2021
(86) PCT No.: PCT/JP2021/044904

§ 371 Date: May 17, 2024

(51) Int. Cl. H04B 10/079; H04J 14/02

(52) U.S. Cl. CPC H04B 10/07955; H04J 14/02

(57) ABSTRACT

The invention presents an optical transmission system and control method aimed at minimizing gain variation across wavelengths. The system has end stations exchanging WDM signals over a fiber optic cable with repeater stations. The repeaters split the WDM signals into multiple subbands which are separately amplified by optical amplifiers dedicated to each subband frequency range. There is a first subband with relatively shorter wavelengths and a second subband with relatively longer wavelengths. A monitoring unit tracks the output power of the longest wavelength channel in the first subband and the shortest wavelength channel in the second subband received at one end station. A control unit sends signals to the transmitting end station to adjust the gains, working to minimize the difference in output power between those two monitored wavelength channels. This aims to reduce gain variation across the full range of wavelengths in the WDM optical transmission system.

### TECHNICAL FIELD

The present invention relates to an optical transmission system and the like and particularly relates to an optical transmission system and the like using an optical fiber as a transmission channel.

### BACKGROUND ART

Optical transmission systems using optical fibers as transmission channels are known. Wavelength bands such as the conventional band (C-band) and the long wave band (L-band) are particularly used as optical communication wavelength bands in the optical transmission systems in consideration of a transmission loss and the like of an optical fiber. The wavelength band of the C-band is 1530 nm to 1565 nm, and the wavelength band of the L-band is 1565 nm to 1625 nm. The wavelength band of the C-band provides high optical transmittance in an optical fiber. In other words, the wavelength band of the C-band provides a low transmission loss in an optical fiber. Therefore, the wavelength band in the C-band is suitable for long-distance transmission.

For example, such an optical transmission system is configured to include a pair of terminal stations performing transmission and reception, an optical fiber as a transmission channel connecting between the pair of terminal stations, and a plurality of repeaters relaying the optical fiber. Each of the plurality of repeaters includes an optical amplification unit amplifying signal light that attenuates during propagation through a long-distance optical fiber. An impurity-doped optical fiber amplifier amplifying signal light itself is used as the optical amplification unit. Examples of the impurity-doped optical fiber amplifier include an erbium-doped optical fiber amplifier (EDFA) in which erbium (Er) ions as an example of rare-earth ions are doped into an optical fiber as impurities.

A general tendency of an amplification characteristic of an impurity-doped optical fiber amplifier is that the gain of signal light at a long wavelength in a wavelength band of amplified signal light is large, and the gain of signal light at a short wavelength is small. The gain of an impurity-doped optical fiber amplifier in a repeater inserted into an optical fiber is adjusted in such a way that the output level of signal light at a short wavelength in a wavelength band of input and amplified beams of signal light exceeds a predetermined level in consideration of the tendency of the amplification characteristic. Then, equalization processing of aligning the output levels of channels in the wavelength band of the beams of signal light amplified by one impurity-doped optical fiber amplifier is performed by cutting off a part exceeding the predetermined level by an equalizer connected to a stage next to the impurity-doped optical fiber amplifier. The part cut off through the equalization processing by the equalizer does not contribute to optical transmission by an optical fiber and therefore becomes an energy loss. An optical transmission system that can reduce the energy loss is desired.

PTL 1 relates to a method for amplifying wavelength division multiplexed (WDM) signal light. PTL 1 proposes an amplification method of dividing wavelength division multiplexed signal light into beams of signal light in a plurality of wavelength bands by a demultiplexer, amplifying divided beams of signal light in each wavelength band by an optical amplification unit related to the wavelength band, and then multiplexing the amplified beams of signal light in the wavelength bands by a multiplexer. Further, PTL 1 proposes branching part of signal light in each wavelength band amplified by the optical amplification unit, measuring the power of the branched light, and individually adjusting the gain of the optical amplification unit, based on the measurement result; and performing design in such a way that the inter-wavelength deviation between optical output levels consequently occurring in the optical amplification unit falls within a preset range.

### CITATION LIST

### Patent Literature

PTL 1: Japanese Unexamined Patent Application Publication No. 2006-066862.

PTL 2: International Application Publication No. WO 2020/209170.

### SUMMARY OF INVENTION

### Technical Problem

An optical amplification unit included in a repeater in an optical transmission system and an energy loss caused by the equalization processing by an equalizer will be considered. For example, an energy loss caused by the equalization processing by an equalizer when a configuration as proposed by PTL 1 in which wavelength division multiplexed signal light is divided into beams of signal light in a plurality of wavelength bands by the demultiplexing device, the divided beams of signal light in each wavelength band are amplified by an optical amplification unit related to the wavelength band, and then the amplified beams of signal light in the wavelength bands are multiplexed by the multiplexing device is applied will be considered (FIG. 13B).

When such a configuration is employed, the width of a wavelength band of signal light, the wavelength band being amplified by each optical amplification unit, becomes narrower compared with a case of amplifying wavelength division multiplexed signal light as-is by one optical amplification unit as illustrated in FIG. 13A. Consequently, the difference between the gain of signal light at a long wavelength and the gain of signal light at a short wavelength is reduced in a wavelength band of beams of signal light amplified by each optical amplification unit. As a result, even when the gain of an optical amplification unit is adjusted in such a way that the output level of signal light at a short wavelength in a wavelength band of beams of signal light input to and amplified by each optical amplification unit exceeds a predetermined level, a part exceeding the predetermined level is reduced. Consequently, it is expected that even when the equalization processing of cutting off the part exceeding the predetermined level and aligning the output levels of channels in the wavelength band of the beams of signal light amplified by the optical amplification unit is performed, the cut-off part is reduced, and an energy loss caused by the equalization processing in the equalizer is reduced.

A new issue of the configuration as proposed by PTL 1 in which wavelength division multiplexed signal light is divided into beams of signal light in a plurality of wavelength bands by the demultiplexing device, the divided beams of signal light in each wavelength band are amplified by an optical amplification unit related to the wavelength band, and then the amplified beams of signal light in the wavelength bands are multiplexed by the multiplexing device will be examined.

An energy loss caused by gain variation occurring in optical amplification of broadband wavelength division multiplexed signal light is expected to be reduced by employing the configuration as proposed by PTL 1 in which wavelength division multiplexed signal light is divided into beams of signal light in a plurality of wavelength bands by the demultiplexing device, the divided beams of signal light in each wavelength band are amplified by an optical amplification unit related to the wavelength band, and then the amplified beams of signal light in the wavelength bands are multiplexed by the multiplexing device.

When the pump light output decreases due to aging degradation of a pump light source in an optical amplification unit in the configuration in which divided beams of signal light in each wavelength band are amplified by an optical amplification unit related to the wavelength band, a gap in output intensity of a received signal occurs at a boundary between sub-bands (FIG. 14).

Since an acceptable limit of variation in the standard deviation in output intensity caused by aging degradation is about 0.03 dB per amplifier, the gap needs to be kept to 0.03 dB or less. Therefore, filling the gap in output intensity caused by aging degradation is an issue.

An object of the present invention is to, in view of the issue described above, provide an optical transmission system with a small amount of gain variation in a broadband and a method for controlling the system.

### Solution to Problem

In order to achieve the object, an optical transmission system according to the present invention is an optical transmission system including: a pair of terminal stations transmitting and receiving wavelength division multiplexed (WDM) signal light to and from each other; an optical fiber propagating the wavelength division multiplexed signal light transmitted and received by the pair of terminal stations; and at least one repeater inserted into the optical fiber, wherein

the repeater includes an optical amplifier separating the wavelength division multiplexed signal light into a plurality of sub-bands including beams of signal light in a plurality of wavelength bands, amplifying the plurality of separated sub-bands by a plurality of related optical amplification units, and then multiplexing the plurality of amplified sub-bands,

the plurality of separated sub-bands include a first sub-band on a relatively short-wavelength side and a second sub-band on a relatively long-wavelength side, and

the optical transmission system further includes:
a monitoring unit monitoring output power of a channel at a longest wavelength in the first sub-band and output power of a channel at a shortest wavelength in the second sub-band that are received by a terminal station on a reception side out of the pair of terminal stations; and
a control unit transmitting a control signal to a terminal station on a transmission side transmitting the wavelength division multiplexed signal light in such a way as to reduce a gap between output power of a channel at a longest wavelength in the first sub-band and output power of a channel at a shortest wavelength in the second sub-band.

A method for controlling an optical transmission system is a method for controlling an optical transmission system including: a pair of terminal stations transmitting and receiving wavelength division multiplexed (WDM) signal light to and from each other; an optical fiber propagating the wavelength division multiplexed signal light transmitted and received by the pair of terminal stations; and at least one repeater inserted into the optical fiber, the method including,

by the repeater, separating the wavelength division multiplexed signal light into a plurality of sub-bands including beams of signal light in a plurality of wavelength bands, amplifying the plurality of separated sub-bands by a plurality of related optical amplification units, and then multiplexing the plurality of amplified sub-bands, wherein

the plurality of separated sub-bands include a first sub-band on a relatively short-wavelength side and a second sub-band on a relatively long-wavelength side, and

the method further includes:
monitoring output power of a channel at a longest wavelength in the first sub-band and output power of a channel at a shortest wavelength in the second sub-band that are received by a terminal station on a reception side out of the pair of terminal stations; and
transmitting a control signal to a terminal station on a transmission side transmitting the wavelength division multiplexed signal light in such a way as to reduce a gap between output power of a channel at a longest wavelength in the first sub-band and output power of a channel at a shortest wavelength in the second sub-band.

### Advantageous Effects of Invention

The present invention can provide an optical transmission system with a small amount of gain variation in a broadband and a method for controlling the system.

### BRIEF DESCRIPTION OF DRAWINGS

FIG. 1A is a block diagram illustrating an optical transmission system according to an example embodiment based on a superordinate concept of the present invention.

FIG. 1B is a block diagram for illustrating a configuration of a repeater in FIG. 1A.

FIG. 2A is a block diagram illustrating an optical transmission system according to a first example embodiment of the present invention.

FIG. 2B is a block diagram for illustrating a configuration and an amplification characteristic of a repeater in FIG. 2A.

FIG. 2C is a graph for illustrating a fundamental principle related to an amplification characteristic of an optical amplifier.

FIG. 3 is a block diagram for illustrating a more specific configuration of the optical transmission system in FIG. 2A.

FIG. 4 is a graph for illustrating an amplification characteristic of an optical amplification unit included in FIG. 2B.

FIG. 5A is a graph for illustrating a method for controlling an optical transmission system according to a second example embodiment of the present invention.

FIG. 5B is a graph for illustrating a modified example of the method for controlling the optical transmission system according to the second example embodiment of the present invention.

FIG. 6 is a graph for illustrating an effect based on the example embodiment of the present invention.

FIG. 7A is a graph for illustrating the method for controlling the optical transmission system according to the second example embodiment of the present invention.

FIG. 7B is a graph for illustrating the method for controlling the optical transmission system according to the second example embodiment of the present invention.

FIG. 7C is a graph for illustrating the method for controlling the optical transmission system according to the second example embodiment of the present invention.

FIG. 8 is a graph for illustrating a method for controlling an optical transmission system according to a third example embodiment of the present invention.

FIG. 9 is a graph for illustrating a method for controlling an optical transmission system according to a fourth example embodiment of the present invention.

FIG. 10 is a graph for illustrating a method for controlling an optical transmission system according to a fifth example embodiment of the present invention.

FIG. 11A is a graph for illustrating an amplification characteristic of an optical amplifier in the optical transmission system according to the fifth example embodiment of the present invention.

FIG. 11B is a graph for illustrating an amplification characteristic of the optical amplifier in the optical transmission system according to the fifth example embodiment of the present invention.

FIG. 12 is a graph for illustrating a method for controlling an optical transmission system according to a sixth example embodiment of the present invention.

FIG. 13A is a conceptual diagram for illustrating an amplification characteristic of the optical amplifier in Background Art and an energy loss caused by equalization processing.

FIG. 13B is a conceptual diagram for illustrating an amplification characteristic of the optical amplifier in Background Art and an energy loss caused by the equalization processing assuming application of the configuration proposed by PTL 1.

FIG. 14 is a graph for illustrating an amplification characteristic assuming occurrence of aging in the optical amplifier in FIG. 13B.

### EXAMPLE EMBODIMENT

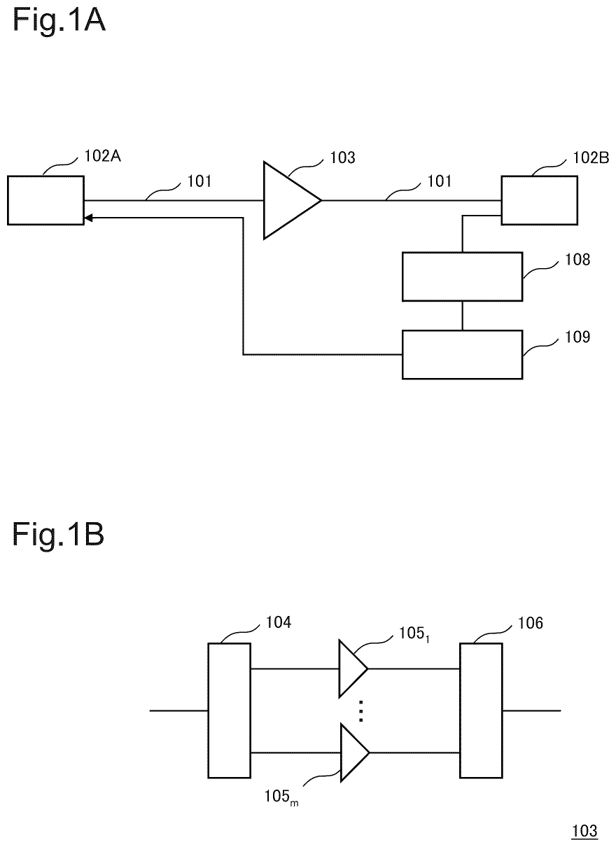

Before describing specific example embodiments of the present invention, an example embodiment based on a superordinate concept of the present invention will be described. FIG. 1A is a block diagram illustrating an optical transmission system according to the example embodiment based on the superordinate concept of the present invention. FIG. 1B is a block diagram for illustrating a configuration of a repeater in FIG. 1A. For example, the optical transmission system in FIG. 1A is a system including terrestrial terminal stations and an optical fiber connecting between the terminal stations and propagating wavelength division multiplexed signal light. A submarine cable system or the like using a submarine cable as the optical fiber is assumed.

The optical transmission system in FIG. 1A includes terminal stations 102A and 102B as an example of a pair of terminal stations transmitting and receiving wavelength division multiplexed (WDM) signal light to and from each other, an optical fiber 101 propagating the wavelength division multiplexed signal light transmitted and received by the terminal stations 102A and 102B, and at least one repeater 103 inserted into the optical fiber 101. As illustrated in FIG. 1B, the repeater 103 in FIG. 1A includes a demultiplexer 104, a plurality of optical amplification units 105₁ to 105ₘ (where m denotes an integer equal to or greater than 2), and a multiplexer 106.

The demultiplexer 104 divides wavelength division multiplexed signal light input to the repeater 103 into a plurality of sub-bands including beams of signal light in a plurality of wavelength bands. The plurality of optical amplification units 105₁ to 105ₘ amplify wavelength division multiplexed signal light divided into the plurality of sub-bands, respectively. Each of the plurality of optical amplification units 105₁ to 105ₘ is an optical amplifier typified by an erbium-doped optical fiber amplifier (EDFA) and is an optical amplifier amplifying an optical signal with pump light and outputting the amplified signal. The multiplexer 106 multiplexes the wavelength division multiplexed signal light amplified by the optical amplification units 105₁ to 105ₘ and outputs the multiplexed light.

The plurality of sub-bands in the optical transmission system in FIG. 1A at least include a first sub-band on the relatively short-wavelength side and a second sub-band on the relatively long-wavelength side.

The optical transmission system in FIG. 1A further includes a monitoring unit 108 monitoring the output power of a channel at the longest wavelength in the first sub-band and the output power of a channel at the shortest wavelength in the second sub-band that are received by a terminal station on the reception side out of the pair of terminal stations.

The optical transmission system in FIG. 1A further includes a control unit 109 transmitting a control signal to a terminal station on the transmission side transmitting the wavelength division multiplexed signal light in such a way as to reduce the gap between the output power of the channel at the longest wavelength in the first sub-band and the output power of the channel at the shortest wavelength in the second sub-band.

The monitoring unit 108 in the optical transmission system in FIG. 1A monitors the output power of the channel at the longest wavelength in the first sub-band on the relatively short-wavelength side and further monitors the output power of the channel at the shortest wavelength in the second sub-band on the relatively long-wavelength side.

Furthermore, the control unit 109 transmits a control signal in such a way as to reduce the gap between the output power of the channel at the longest wavelength in the first sub-band and the output power of the channel at the shortest wavelength in the second sub-band. The control signal for reducing the gap is transmitted to the terminal station on the transmission side transmitting the wavelength division multiplexed signal light.

The terminal station on the transmission side changes a state with respect to transmission of the wavelength division multiplexed (WDM) signal light in accordance with the control signal. As a result, the gap between the output power of the channel at the longest wavelength in the first sub-band and the output power of the channel at the shortest wavelength in the second sub-band is reduced. By reduction in the gap in the amplification characteristic resulting from optical amplification for each separated sub-band, an energy loss caused by the equalization processing can be reduced. As a result, an optical transmission system with improved energy utilization efficiency can be provided, and performance of the optical transmission system can be maintained.

Even when aging occurs in the optical amplifier and the like included in the repeater 103 after the start of operation in the optical transmission system in FIG. 1A, variation in the amplification characteristic of the optical amplifier included in the repeater 103 is reduced by control of reducing the gap between the output power of the channel at the longest wavelength in the first sub-band and the output power of the channel at the shortest wavelength in the second sub-band; and an optical transmission system with improved energy utilization efficiency can be provided, and performance of the optical transmission system can be maintained. A more specific optical transmission system and a method for controlling the system will be described below.

### First Example Embodiment

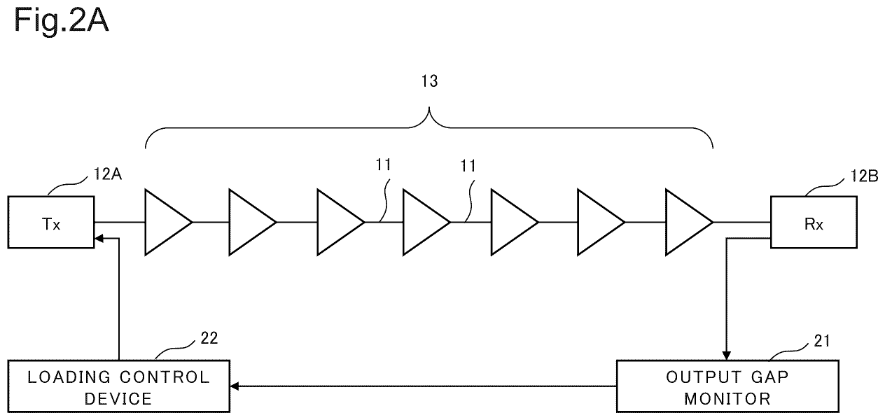

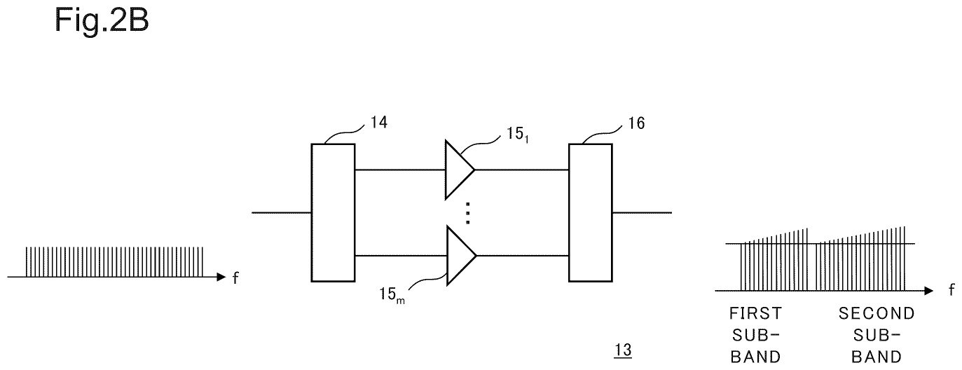

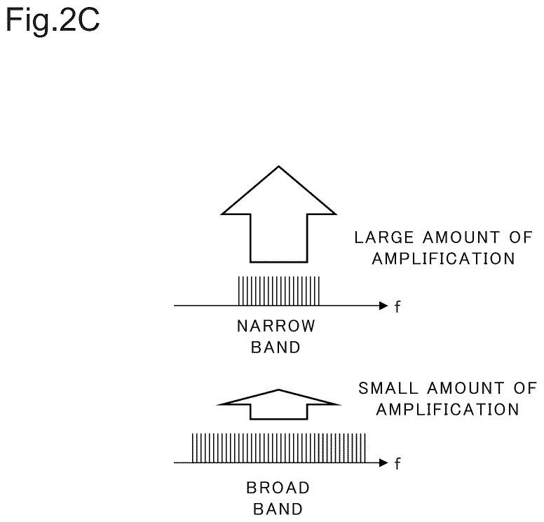

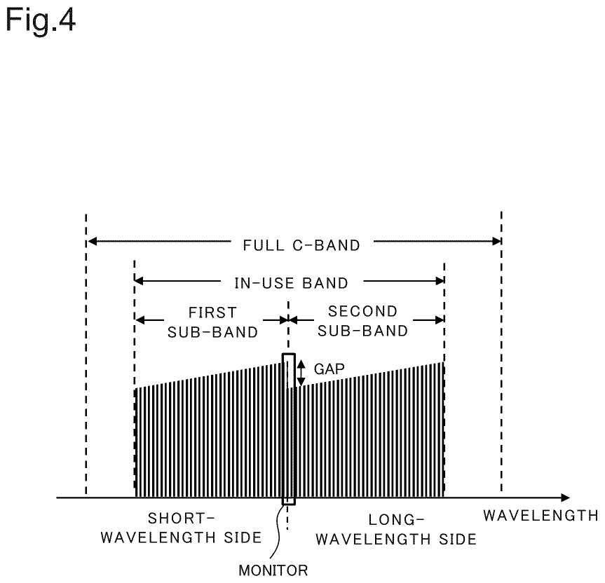

An optical transmission system according to a first example embodiment of the present invention and a method for controlling the system will be described. FIG. 2A is a block diagram illustrating the optical transmission system according to the first example embodiment of the present invention. FIG. 2B is a block diagram for illustrating a configuration and an amplification characteristic of a repeater in FIG. 2A. FIG. 2C is a graph for illustrating a fundamental principle related to an amplification characteristic of an optical amplifier. FIG. 4 is a graph for illustrating an amplification characteristic of an optical amplification unit included in FIG. 2B.

The optical transmission system in FIG. 2A includes a terminal station 12A (a terminal station Tx on the transmission side) transmitting wavelength division multiplexed (WDM) signal light, a terminal station 12B (a terminal station Rx on the transmission side) receiving wavelength division multiplexed signal light, and an optical fiber 11 propagating wavelength division multiplexed signal light transmitted and received by the terminal stations 12A and 12B. The optical transmission system in FIG. 2A further includes at least one repeater 13 inserted into the optical fiber 11. A case of seven repeaters 13 being inserted into the optical fiber 11 is illustrated in FIG. 2A as an example.

As illustrated in FIG. 2B, the repeater 13 in FIG. 2A includes a demultiplexer 14, a plurality of optical amplification units 15₁ to 15ₘ (where m denotes an integer equal to or greater than 2), and a multiplexer 16. The demultiplexer 14 divides wavelength division multiplexed signal light input to the repeater 13 into a plurality of sub-bands including beams of signal light in a plurality of wavelength bands. The plurality of optical amplification units 15₁ to 15ₘ amplify wavelength division multiplexed signal light divided into the plurality of sub-bands, respectively. Each of the plurality of optical amplification units 15₁ to 15ₘ is an optical amplifier typified by an erbium-doped optical fiber amplifier (EDFA) and is an optical amplifier amplifying an optical signal with pump light and outputting the amplified signal. The multiplexer 16 multiplexes wavelength division multiplexed signal light amplified by the optical amplification units 15₁ to 15ₘ and outputs the multiplexed light.

The plurality of sub-bands in the optical transmission system in FIG. 2A at least include a first sub-band on the relatively short-wavelength side and a second sub-band on the relatively long-wavelength side.

The optical transmission system in FIG. 2A further includes an output gap monitor 21 monitoring the output power of a channel at the longest wavelength in the first sub-band and the output power of a channel at the shortest wavelength in the second sub-band that are received by the terminal station Rx on the reception side.

The optical transmission system in FIG. 2A further includes a loading control device 22 transmitting a control signal to the terminal station Tx on the transmission side in such a way as to reduce the gap between the output power of the channel at the longest wavelength in the first sub-band and the output power of the channel at the shortest wavelength in the second sub-band.

The output gap monitor 21 in the optical transmission system in FIG. 2A monitors the output power of the channel at the longest wavelength in the first sub-band on the relatively short-wavelength side and further monitors the output power of the channel at the shortest wavelength in the second sub-band on the relatively long-wavelength side.

Furthermore, the loading control device 22 transmits a control signal in such a way as to reduce the gap between the output power of the channel at the longest wavelength in the first sub-band and the output power of the channel at the shortest wavelength in the second sub-band. The control signal for reducing the gap is transmitted to the terminal station Tx on the transmission side.

The terminal station Tx on the transmission side changes a state with respect to transmission of wavelength division multiplexed signal light in accordance with the control signal. As a result, the gap between the output power of the channel at the longest wavelength in the first sub-band and the output power of the channel at the shortest wavelength in the second sub-band is reduced. Thus, by reduction in the gap in the amplification characteristic resulting from optical amplification for each separated sub-band, an energy loss caused by the equalization processing can be reduced. As a result, an optical transmission system with improved energy utilization efficiency can be provided, and performance of the optical transmission system can be maintained.

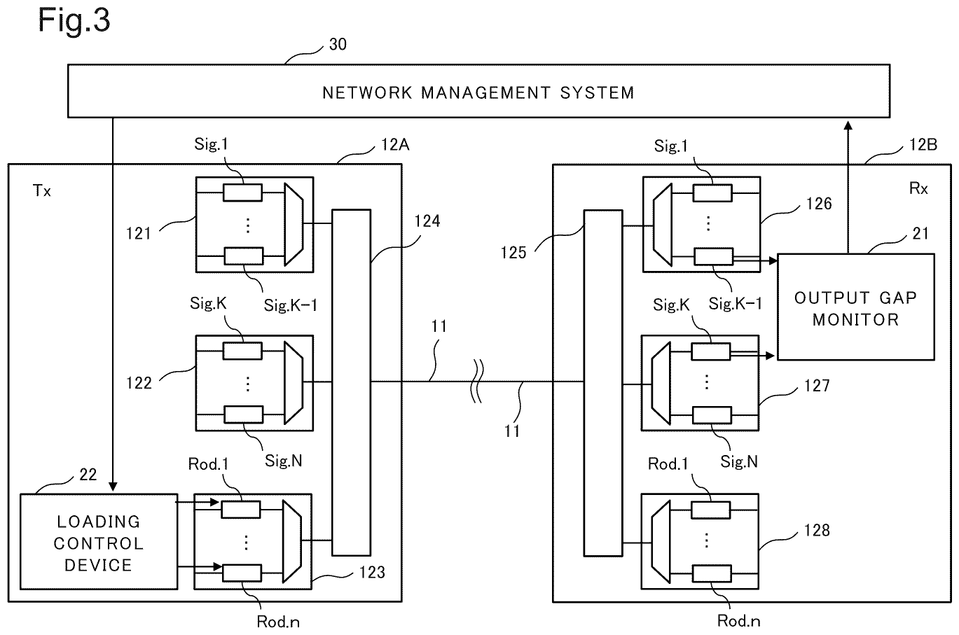

FIG. 3 is a block diagram for illustrating a more specific configuration of the optical transmission system in FIG. 2A. The optical transmission system in FIG. 3 includes the terminal station 12A (the terminal station Tx on the transmission side), the terminal station 12B (the terminal station Rx on the transmission side), and the optical fiber 11 propagating wavelength division multiplexed signal light that are illustrated in FIG. 2A and further includes a network management system 30. The network management system 30 centrally controls the entire optical transmission system in FIG. 2A, and a configuration in which the loading control device 22 is controlled based on the output of the output gap monitor 21 is particularly illustrated in the present example embodiment. Note that illustration of the repeater 13 inserted into the optical fiber 11 is omitted in FIG. 3.

The terminal station Tx on the transmission side in the optical transmission system in FIG. 3 is configured to include a configuration for wavelength division multiplexing transmitted signal light and dummy light related to loading, and the loading control device 22. The terminal station Tx on the transmission side includes a multiplexing unit 121 wavelength division multiplexing beams of signal light on a channel #1 to a channel #K-1 (Sig. 1 to Sig. K-1), a multiplexing unit 122 wavelength division multiplexing beams of signal light on a channel #K to a channel #N (Sig. K to Sig. N). For example, N and K are integers satisfying N>K≥2. For convenience of description, it is assumed that channel numbers from the channel #1 to the channel #N are assigned in ascending order of wavelength. The terminal station Tx on the transmission side further includes a multiplexing unit 123 wavelength division multiplexing #1 to #n beams of dummy light (Rod. 1 to Rod. n), a multiplexing means 124 for multiplexing the outputs of the multiplexing units 121, 122, and 123, and the loading control device 22 controlling the multiplexing unit 123 in accordance with an input control signal. The loading control device 22 instructs the multiplexing unit 123 to, for example, output or shut off the #1 to #n beams of dummy light or attenuate the optical power of the #1 to #n beams of dummy light in accordance with the input control signal.

The terminal station Rx on the reception side in the optical transmission system in FIG. 3 is configured to include a configuration for demultiplexing received signal light and dummy light related to loading, and the output gap monitor 21. The terminal station Rx on the reception side includes a demultiplexing means 125 for demultiplexing wavelength division multiplexed signal light propagating through the optical fiber 11, a demultiplexing unit 126 performing demultiplexing for beams of signal light on the channel #1 to the channel #K-1 (Sig. 1 to Sig. K-1), and a demultiplexing unit 127 performing demultiplexing for beams of signal light on the channel #K to the channel #N (Sig. K to Sig. N). The terminal station Rx on the reception side further includes a demultiplexing unit 128 performing demultiplexing for the #1 to #n beams of dummy light and the output gap monitor 21.

The output gap monitor 21 monitors the output power of the signal light on the channel #K-1 (Sig. K-1) output by the demultiplexing unit 126 and the output power of the signal light on the channel #K (Sig. K) output by the demultiplexing unit 127. For example, the output gap monitor 21 monitors an amount of gap between the output power of the signal light on the channel #K-1 (Sig. K-1) and the output power of the signal light on the channel #K (Sig. K). The signal light on the channel #K-1 (Sig. K-1) corresponds to the channel at the longest wavelength in the first sub-band, and the signal light on the channel #K (Sig. K) corresponds to the channel at the shortest wavelength in the second sub-band.

The terminal station Tx on the transmission side includes the multiplexing unit 123 wavelength division multiplexing #1 to #n beams of dummy light (Rod. 1 to Rod. n), the multiplexing means 124 for multiplexing the outputs of the multiplexing units 121, 122, and 123, and the loading control device 22 controlling the multiplexing unit 123 in accordance with an input control signal.

In accordance with the input control signal, the loading control device 22 instructs the multiplexing unit 123 to output or shut off the #1 to #n beams of dummy light (Rod. 1 to Rod. n) from the multiplexing unit 123 or attenuate the dummy light. Consequently, the loading control device 22 controls an amount of loading in the optical transmission system.

### Operation in Example Embodiment

Next, the operation of the optical transmission system according to the present example embodiment will be described. In the optical transmission system illustrated in each of FIG. 2A and FIG. 3, wavelength division multiplexed (WDM) signal light transmitted by the terminal station 12A propagates through the optical fiber 11 and is received by the terminal station 12B. The wavelength division multiplexed signal light attenuating while propagating through the long-distance optical fiber 11 is amplified by the repeater 13 inserted into the optical fiber 11, and a predetermined level of gain is maintained. The wavelength division multiplexed signal light is separated into a plurality of sub-bands including beams of signal light in a plurality of wavelength bands in the repeater 13. The demultiplexer 14 is provided in the repeater 13 in FIG. 2B as a means for separating the wavelength division multiplexed signal light, and the wavelength division multiplexed signal light is divided into a plurality of sub-bands by the demultiplexer 14. For example, the plurality of sub-bands are first to m-th sub-bands (where m is an integer equal to or greater than 2). Wavelength division multiplexed signal light is amplified in a form of an optical signal with introduction of pump light in an optical amplifier. As a characteristic of an optical amplifier, an amount of amplification for a narrowband input signal tends to be greater, and an amount of amplification for a broadband input signal tends to be smaller even when the same pump light is introduced, as illustrated in FIG. 2C.

The plurality of separated sub-bands are amplified by the optical amplification units 15₁ to 15ₘ related to the respective sub-bands, and then the plurality of amplified sub-bands are multiplexed by the multiplexer 16 in the repeater 13. It is assumed that change (aging) in a characteristic of the optical transmission system occurs with the elapse of time after the start of operation.

The optical transmission system according to the present example embodiment particularly handles aging related to the amplification characteristic of the plurality of optical amplification units 15₁ to 15ₘ, and for example, a case of separating a plurality of sub-bands in such a way as to include a first sub-band on the relatively short-wavelength side and a second sub-band on the relatively long-wavelength side is assumed. For example, the first sub-band is a sub-band including beams of signal light (Sig. 1 to Sig. K-1) on a channel #1 to a channel #K-1, and for example, the second sub-band is a sub-band including beams of signal light (Sig. K to Sig. N) on a channel #K to a channel #N. In this case, the beams of signal light (Sig. 1 to Sig. K-1) on the channel #1 to the channel #K-1 are amplified by the optical amplification unit 15₁, the beams of signal light (Sig. K to Sig. N) on the channel #K to the channel #N are amplified by the optical amplification unit 15₂, and the amplified beams are multiplexed by the multiplexer 16 in the repeater 13.

The wavelength division multiplexed signal light propagates through the optical fiber 11 and is received by the terminal station 12B. The wavelength division multiplexed signal light is demultiplexed by the demultiplexing means 125, the demultiplexing unit 126, and the demultiplexing unit 127 in the terminal station 12B. The output gap monitor 21 monitors the output power of the signal light (Sig. K-1) on the channel #K-1 being the channel at the longest wavelength in the first sub-band and the output power of the signal light (Sig. K) on the channel #K being the channel at the shortest wavelength in the second sub-band. Then, when a gap exists between the output power of the signal light (Sig. K-1) on the channel #K-1 and the output power of the signal light (Sig. K) on the channel #K being the channel at the shortest wavelength in the second sub-band, control is performed in such a way as to reduce the gap. In FIG. 2A, when a gap exists between the output power of the signal light (Sig. K-1) on the channel #K-1 and the output power of the signal light (Sig. K) on the channel #K being the channel at the shortest wavelength in the second sub-band, a control signal is transmitted to the terminal station 12A on the transmission side transmitting the wavelength division multiplexed signal light. FIG. 2A illustrates a situation in which the output gap monitor 21 transmits a control signal to the loading control device 22; and FIG. 3 illustrates a situation in which the output gap monitor 21 transmits a monitoring result to the network management system 30, and the network management system 30 transmits a control signal to the loading control device 22, based on the monitoring result.

The loading control device 22 provides an instruction to output or shut off the #1 to #n beams of dummy light (Rod. 1 to Rod. n) or attenuate the dummy light. An optical amplifier has the amplification characteristic as illustrated in FIG. 2C, and therefore by instructing the loading control device 22 to make a change in the dummy light such as from output to shutoff, from shutoff to output, or from output to attenuation, the gain of each of the optical amplification units 15₁ and 15₂ in the repeater 13 can be individually changed from the terminal station 12A.

### Effects of Example Embodiment

The output gap monitor 21 in the optical transmission system in each of FIG. 2A and FIG. 3 monitors the output power of the signal light (Sig. K-1) on the channel #K-1 being the channel at the longest wavelength in the first sub-band on the relatively short-wavelength side and further monitors the output power of the signal light (Sig. K) on the channel #K being the channel at the shortest wavelength in the second sub-band on the relatively long-wavelength side. Furthermore, each of the output gap monitor 21 in FIG. 2A and the network management system 30 in FIG. 3 transmits a control signal in such a way as to reduce the gap between the output power of the signal light (Sig. K-1) on the channel #K-1 and the output power of the signal light (Sig. K) on the channel #K. The control signal reducing the gap is transmitted to the terminal station 12A on the transmission side (the terminal station Tx on the transmission side) transmitting the wavelength division multiplexed signal light. The control signal is transmitted particularly to the loading control device 22 in the terminal station 12A on the transmission side transmitting the wavelength division multiplexed signal light.

The terminal station on the transmission side changes a state with respect to transmission of the wavelength division multiplexed (WDM) signal light in accordance with the control signal. As a result, the gap between the output power of the signal light (Sig. K-1) on the channel #K-1 and the output power of the signal light (Sig. K) on the channel #K is reduced. Thus, by reduction in the gap in the amplification characteristic resulting from optical amplification for each separated sub-band, an energy loss caused by the equalization processing can be reduced. As a result, an optical transmission system with improved energy utilization efficiency can be provided, and performance of the optical transmission system can be maintained.

Even when aging occurs in the optical amplification units 15₁ to 15ₘ and the like included in the repeater 13 after the start of operation in the optical transmission system in each of FIG. 2A and FIG. 3, variation in the amplification characteristic of the optical amplification units 15₁ to 15ₘ included in the repeater 13 is reduced by control of reducing the gap between the output power of the channel at the longest wavelength in the first sub-band and the output power of the channel at the shortest wavelength in the second sub-band; and an optical transmission system with improved energy utilization efficiency can be provided, and performance of the optical transmission system can be maintained.

Specific details of the control will be described below in a sequential order. The gap between the output power of the channel at the longest wavelength in the first sub-band and the output power of the channel at the shortest wavelength in the second sub-band is reduced.

### Second Example Embodiment

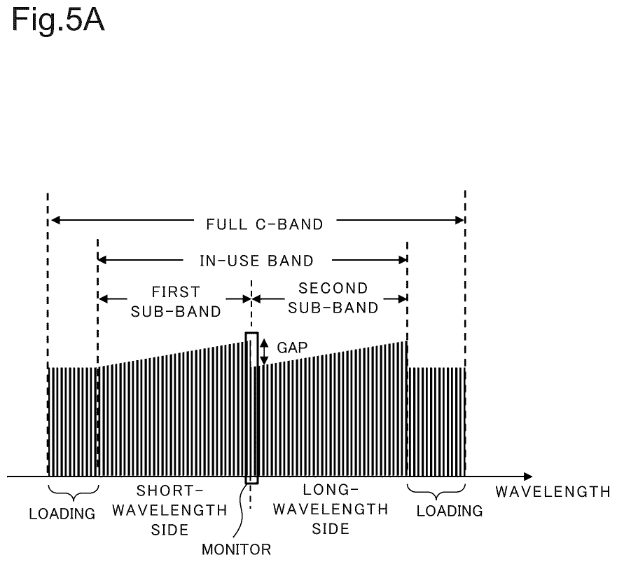

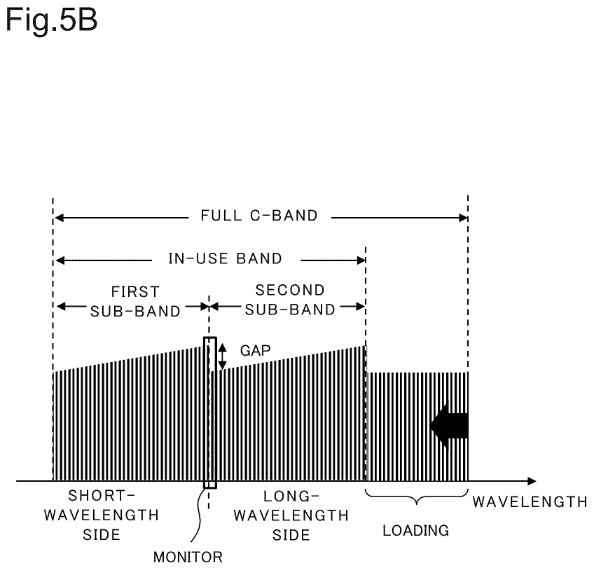

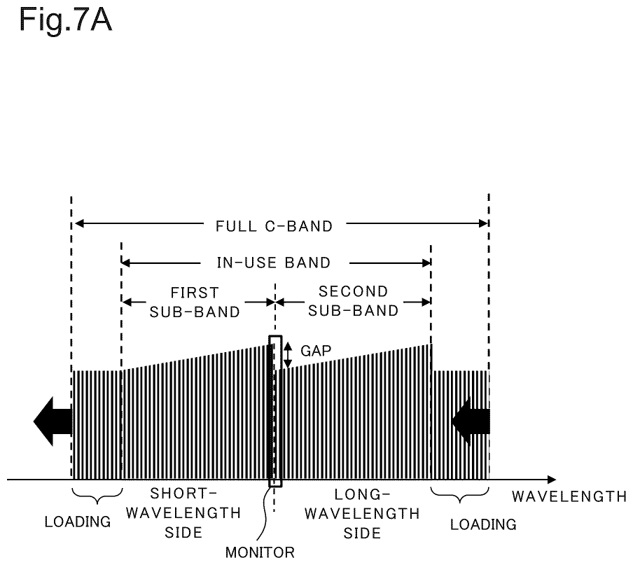

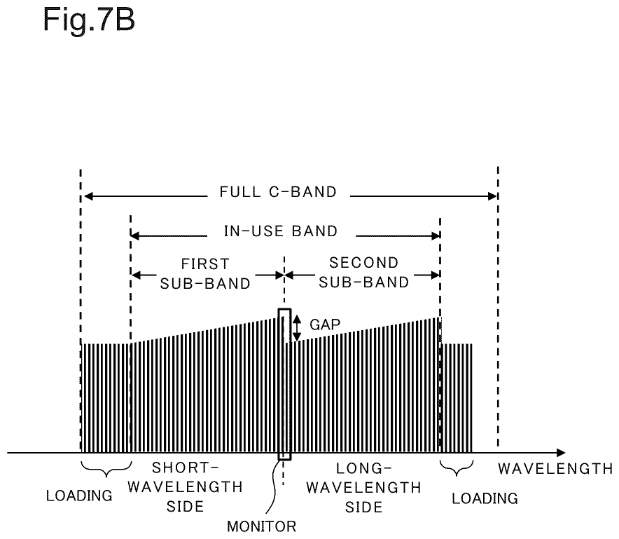

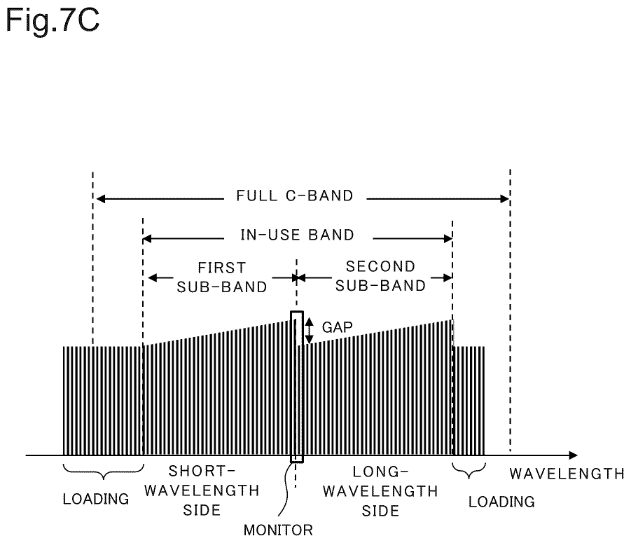

An optical transmission system according to a second example embodiment of the present invention and a method for controlling the system will be described. FIG. 5A is a graph for illustrating the method for controlling the optical transmission system according to the second example embodiment of the present invention. FIG. 7A to FIG. 7C are graphs for illustrating the method for controlling the optical transmission system according to the second example embodiment of the present invention. The present example embodiment is an example embodiment using the configuration of the optical transmission system in each of FIG. 2A and FIG. 3 described above and is characterized by the operation of the optical transmission system and the method for controlling the optical transmission system. Assuming use of the configuration of the optical transmission system illustrated in each of FIG. 2A and FIG. 3 described above, description of the configuration is omitted in the present example embodiment.

A “frequency band used in transmission of wavelength division multiplexed signal light” is referred to as an “in-use band,” and the “entire C-band” (wavelength band: 1530 nm to 1565 nm) is referred to as a “full C-band” in the optical transmission system according to example embodiments herein. The full C-band includes a plurality of sub-bands (a first sub-band and a second sub-band) used in transmission of wavelength division multiplexed signal light as illustrated in FIG. 4 and further includes a band including wavelengths shorter than those in the first sub-band on the short-wavelength side and a band including wavelengths longer than those in the second sub-band on the long-wavelength side.

An optical transmission system is designed in such a way as to include a plurality of channels used at the start of operation and further include a plurality of channels in an unused state at the start of operation (dark channels) assuming future augmentation. Control such as outputting dummy light in a channel in an unused state is performed in consideration of the amplification characteristic of an amplification unit in a repeater illustrated in FIG. 2C. Then, a change such as supplying signal light in a channel in an unused state and shutting off dummy light is made after the start of operation.

FIG. 5A illustrates a state in which dummy light is output in a band in the full C-band including wavelengths shorter than those in the first sub-band, and dummy light is output in a band including wavelengths shorter than those in the second sub-band.

Similarly to the example embodiment described above, the output power of a channel at the longest wavelength in the first sub-band on the relatively short-wavelength side is monitored, and the output power of a channel at the shortest wavelength in the second sub-band on the relatively long-wavelength side is also monitored in the optical transmission system according to the present example embodiment and the method for controlling the system. Furthermore, a control signal is transmitted in such a way as to reduce the gap between the output power of the channel at the longest wavelength in the first sub-band and the output power of the channel at the shortest wavelength in the second sub-band.

Control of changing an amount of loading as indicated by two arrows in FIG. 7A is assumed to be performed in accordance with the control signal in the optical transmission system according to the present example embodiment and the method for controlling the system. More specifically, for example, the control is control of decreasing an amount of loading at wavelengths longer than those in the second sub-band, such as a change from the state illustrated in FIG. 7A to a state illustrated in FIG. 7B. For example, the control of decreasing an amount of loading at wavelengths longer than those in the second sub-band is control by the loading control device 22 in FIG. 3 and is achieved by shutting off one or more beams of dummy light at wavelengths longer than those in the second sub-band by the loading control device 22. As understood from the amplification characteristic illustrated in FIG. 2C, by narrowing of the band of an input signal, an amount of amplification by an optical amplification unit increases, and the gain of the optical amplification unit increases. Consequently, the output power of each beam of signal light in wavelength division multiplexed signal light in the second sub-band increases, and the gap between the output power of the channel at the longest wavelength in the first sub-band and the output power of the channel at the shortest wavelength in the second sub-band can be reduced.

By shutting off one or more beams of dummy light at wavelengths longer than those in the second sub-band by the control by the loading control device 22, the gap in the output power can be reduced. The control of reducing the gap in the output power by shutting off beams of dummy light at wavelengths longer than those in the second sub-band is control of shutting off dummy light in an output state and can be performed until all beams of dummy light are shut off.

When the gap in the output power cannot be reduced by the control of shutting off beams of dummy light at wavelengths longer than those in the second sub-band, for example, performing control of increasing an amount of loading at wavelengths shorter than those in the first sub-band, such as making a change from the state illustrated in FIG. 7B to a state illustrated in FIG. 7C, may be considered. For example, the control of increasing an amount of loading at wavelengths shorter than those in the first sub-band is control by the loading control device 22 in FIG. 3 and is achieved by adding and outputting one or more beams of dummy light at wavelengths shorter than those in the first sub-band by the loading control device 22.

### Effects of Example Embodiment

The optical transmission system according to the present example embodiment and the method for controlling the system can reduce an energy loss caused by the equalization processing, by reduction in the gap in the amplification characteristic resulting from optical amplification for each separated sub-band, similarly to the example embodiment described above. As a result, an optical transmission system with improved energy utilization efficiency can be provided, and performance of the optical transmission system can be maintained.

Furthermore, according to the present example embodiment, the gap in the output power is reduced by the control of decreasing an amount of loading at wavelengths longer than those in the second sub-band on the long-wavelength side. An amount of loading at wavelengths longer than those in the second sub-band is decreased by the technique such as shutting off dummy light, and therefore power consumption related to dummy light can be decreased; and an optical transmission system with further improved energy utilization efficiency can be provided, and performance of the optical transmission system can be maintained.

Further, according to the present example embodiment, the gap in the output power can be further reduced by parallel use of the control of increasing an amount of loading at wavelengths shorter than those in the first sub-band on the short-wavelength side in addition to the control of decreasing an amount of loading at wavelengths longer than those in the second sub-band on the long-wavelength side.

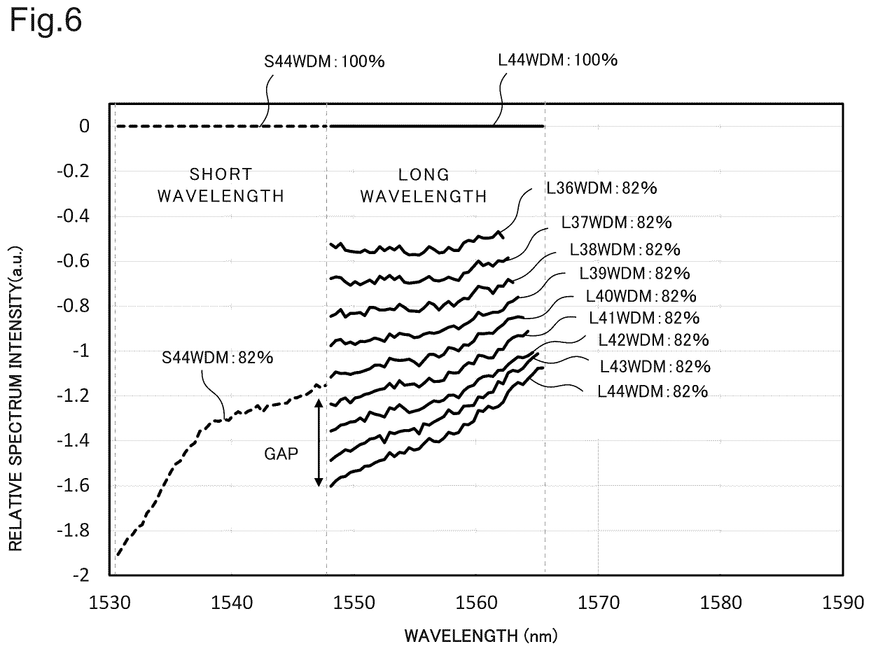

FIG. 6 is a graph for illustrating an effect based on the example embodiment of the present invention. The horizontal axis represents wavelength, and the vertical axis represents relative spectrum intensity. The optical transmission system is designed in such a way that a gap (GAP) does not occur between the output power of the channel at the longest wavelength in the first sub-band and the output power of the channel at the shortest wavelength in the second sub-band when the output of a pump light source in the optical amplification unit is 100%. When the output of the pump light source in the optical amplification unit is decreased from 100% to 82%, a gap (GAP) of about 0.4 dB occurs between the output power of the channel at the longest wavelength in the first sub-band and the output power of the channel at the shortest wavelength in the second sub-band in the output waveform after passing an equalizer, as illustrated in FIG. 6.

On the other hand, the gap (GAP) can be filled by the control of decreasing an amount of loading at wavelengths longer than those in the second sub-band and particularly by decreasing four loading wavelengths in the illustration in FIG. 6, according to the present example embodiment. In other words, the gap (GAP) can be filled by shutting off four beams of dummy light L44, L43, L42, and L41 on the long-wavelength side of the second sub-band. It is further understood from the illustration in FIG. 6 that the relative spectrum intensity of the second sub-band on the long-wavelength side is increased by shutting off the beams of dummy light L40, L39, L38, L37, and L36 on the long-wavelength side.

### Third Example Embodiment

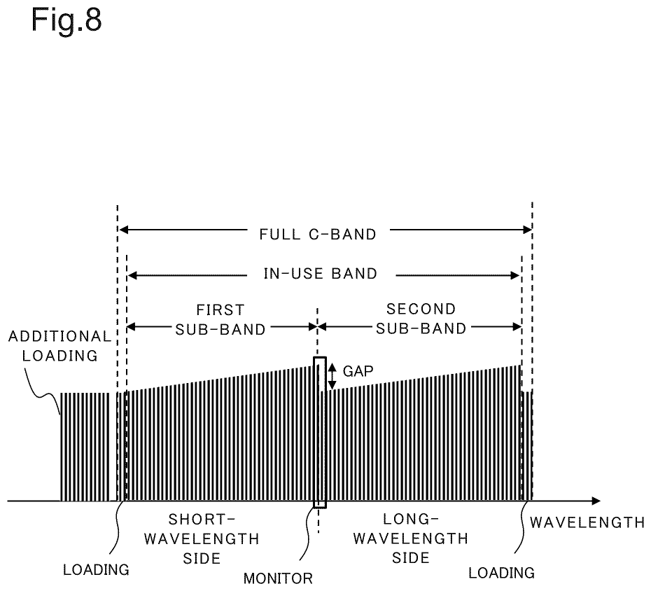

Next, an optical transmission system according to a third example embodiment of the present invention and a method for controlling the system will be described. FIG. 8 is a graph for illustrating the method for controlling the optical transmission system according to the third example embodiment of the present invention. The present example embodiment is an example embodiment using the configuration of the optical transmission system illustrated in each of FIG. 2A and FIG. 3 described above, similarly to the second example embodiment, and is characterized by the operation of the optical transmission system and the method for controlling the optical transmission system. Assuming use of the configuration of the optical transmission system illustrated in each of FIG. 2A and FIG. 3 described above, description of the configuration is omitted in the present example embodiment.

As described above, an optical transmission system is designed in such a way as to include a plurality of channels used at the start of operation and further include a plurality of channels in an unused state at the start of operation (dark channels) assuming future augmentation. A change such as supplying signal light in a channel in an unused state and shutting off dummy light is made after the start of operation. It is assumed that such conversion of a channel in an unused state into a channel in an in-use state makes it difficult to perform the control of reducing the gap in the output power by control of decreasing an amount of loading at wavelengths longer than those in the second sub-band as is the case in the second example embodiment described above.

In other words, it is assumed with long-term operation of the optical transmission system that the in-use band in FIG. 8 gradually approaches the full C-band and an amount of loading itself decreases and that control of reducing the gap in the output power becomes difficult by control of an amount of loading solely in the full C-band.

According to the present example embodiment, by the control of increasing an amount of loading at wavelengths shorter than those in the first sub-band on the short-wavelength side, an amount of amplification by the optical amplification unit decreases due to broadening of the band of an input signal with respect to optical amplification in the first sub-band, and the gain of the optical amplification unit for the first sub-band decreases, as illustrated in FIG. 8. Consequently, the gap in the output power can be reduced.

According to the present example embodiment, the control of increasing an amount of loading at wavelengths shorter than those in the first sub-band on the short-wavelength side represents control of adding an amount of loading in a wavelength band shorter than the full C-band, as illustrated in FIG. 8. Such addition of loading in a band outside the full C-b can also reduce an amount of amplification by the optical amplification unit due to broadening of the band of an input signal with respect to optical amplification in the first sub-band and can decrease the gain of the optical amplification unit in the first sub-band.

### Effects of Example Embodiment

The optical transmission system according to the present example embodiment and the method for controlling the system can reduce an energy loss caused by the equalization processing, by reduction in the gap in the amplification characteristic resulting from optical amplification for each separated sub-band, similarly to the example embodiments described above. As a result, an optical transmission system with improved energy utilization efficiency can be provided, and performance of the optical transmission system can be maintained.

Furthermore, the present example embodiment enables further reduction in the gap in the output power by the control of increasing an amount of loading at wavelengths shorter than those in the first sub-band on the short-wavelength side. At that time, additional loading is performed outside the full C-band, according to the present example embodiment. Specifically, by adding an amount of loading in a wavelength band shorter than the full C-band, an amount of amplification by the optical amplification unit can be reduced with respect to optical amplification in the first sub-band, and the gain of the optical amplification unit in the first sub-band can be decreased. As a result, the gap in the output power can be further reduced.

### Fourth Example Embodiment

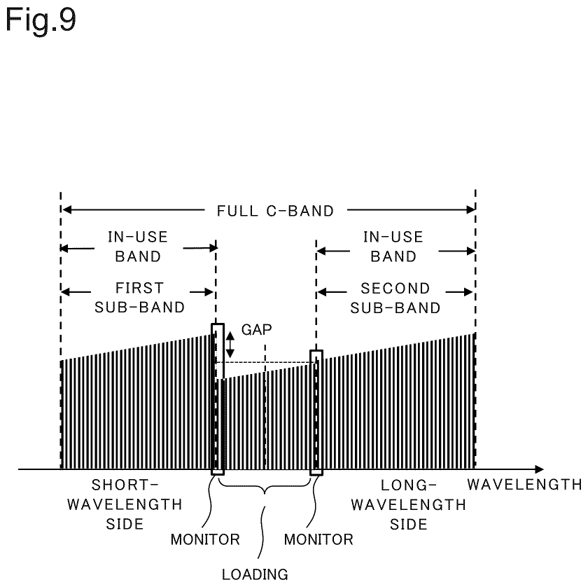

Next, an optical transmission system according to a fourth example embodiment of the present invention and a method for controlling the system will be described. FIG. 9 is a graph for illustrating the method for controlling the optical transmission system according to the fourth example embodiment of the present invention. The present example embodiment is an example embodiment using the configuration of the optical transmission system illustrated in each of FIG. 2A and FIG. 3 described above, similarly to the second example embodiment and the third example embodiment, and is characterized by the operation of the optical transmission system and the method for controlling the optical transmission system. Assuming use of the configuration of the optical transmission system illustrated in each of FIG. 2A and FIG. 3 described above, description of the configuration is omitted in the present example embodiment.

While reduction in the gap in the output power by controlling an amount of loading at wavelengths longer than a plurality of separated sub-bands and controlling an amount of loading at shorter wavelengths has been described in the second example embodiment and the third example embodiment described above, control of an amount of loading according to example embodiments of the present invention is not limited to the above. For example, reduction in the gap in the output power may be considered by controlling an amount of loading in a band between the first sub-band and the second sub-band.

According to the present example embodiment, an in-use band is separated into a first sub-band being a shorter wavelength band and a second sub-band being a longer wavelength band. Then, according to the present example embodiment, an amount of loading in a band between the first sub-band and the second sub-band is controlled, as illustrated in FIG. 9.

The output power of a channel at the longest wavelength in the first sub-band on the relatively short-wavelength side is monitored, and the output power of a channel at the shortest wavelength in the second sub-band on the relatively long-wavelength side is also monitored. Then, a control signal is transmitted in such a way as to reduce the gap between the output power of the channel at the longest wavelength in the first sub-band and the output power of the channel at the shortest wavelength in the second sub-band.

For example, the output power of each beam of signal light in wavelength division multiplexed signal light in the second sub-band can be increased by control of decreasing an amount of loading in a band close to the second sub-band included in an amount of loading in the band between the first sub-band and the second sub-band. Further, the output power of each beam of signal light in wavelength division multiplexed signal light in the first sub-band can be decreased by control of increasing an amount of loading in a band close to the first sub-band included in an amount of loading in the band between the first sub-band and the second sub-band. Such control of an amount of loading in the band between the first sub-band and the second sub-band enables reduction in the gap in the output power.

### Effects of Example Embodiment

The optical transmission system according to the present example embodiment and the method for controlling the system can reduce an energy loss caused by the equalization processing, by reduction in the gap in the amplification characteristic resulting from optical amplification for each separated sub-band, similarly to the example embodiments described above. As a result, an optical transmission system with improved energy utilization efficiency can be provided, and performance of the optical transmission system can be maintained.

Furthermore, the present example embodiment enables further reduction in the gap in the output power by controlling an amount of loading in the band between the first sub-band and the second sub-band.

### Fifth Example Embodiment

Next, an optical transmission system according to a fifth example embodiment of the present invention and a method for controlling the system will be described. The present example embodiment is an example embodiment using the configuration of the optical transmission system illustrated in each of FIG. 2A and FIG. 3 described above, similarly to the second example embodiment to the fourth example embodiment, and is characterized by the operation of the optical transmission system and the method for controlling the optical transmission system. Assuming use of the configuration of the optical transmission system illustrated in each of FIG. 2A and FIG. 3 described above, description of the configuration is omitted in the present example embodiment.

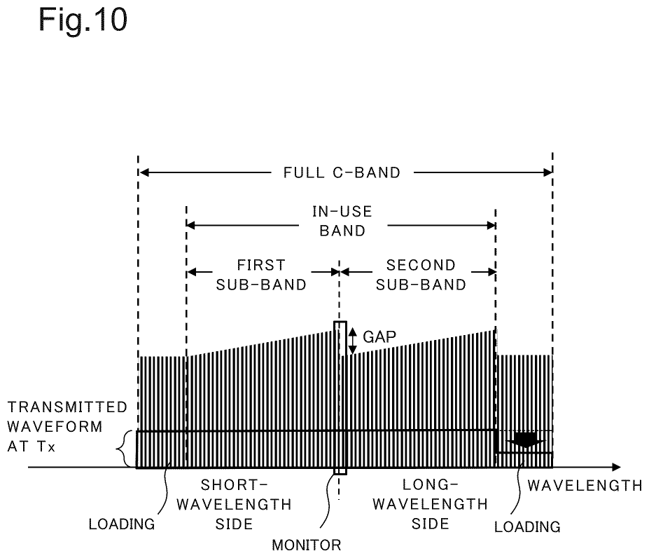

According to the present example embodiment, control of a transmitted waveform at a terminal station on the transmission side is also performed in addition to the control of an amount of loading such as output and shutoff of dummy light in a specific band as described in the second example embodiment to the fourth example embodiment described above. FIG. 10 is a graph for illustrating the method for controlling the optical transmission system according to the fifth example embodiment of the present invention.

The output power of wavelength division multiplexed signal light and the output power of dummy light are increased in the full C-band at the terminal station 12A (the terminal station Tx on the transmission side) in the optical transmission system according to the present example embodiment. FIG. 10 illustrates a state in which dummy light is output in a band in the full C-band including wavelengths shorter than those in a first sub-band, and dummy light is output in a band including wavelengths shorter than those in a second sub-band; and FIG. 10 illustrates a state in which the output power of dummy light is also increased.

The output power of a channel at the longest wavelength in the first sub-band on the relatively short-wavelength side is monitored, and the output power of a channel at the shortest wavelength in the second sub-band on the relatively long-wavelength side is also monitored in the optical transmission system according to the present example embodiment and the method for controlling the system, similarly to the example embodiments described above. Furthermore, a control signal is transmitted in such a way as to reduce the gap between the output power of the channel at the longest wavelength in the first sub-band and the output power of the channel at the shortest wavelength in the second sub-band.

The optical transmission system according to the present example embodiment and the method for controlling the system assume control of changing an amount of loading as indicated by an arrow in FIG. 10. More specifically, the control is control of decreasing an amount of loading at wavelengths longer than those in the second sub-band, and control of attenuating the output power of beams of dummy light at wavelengths longer than those in the second sub-band is performed as the control of decreasing an amount of loading. By the control, an amount of amplification by an optical amplification unit for the second sub-band increases, and the gain of the optical amplification unit increases. Consequently, the output power of each beam of signal light in wavelength division multiplexed signal light in the second sub-band increases, and the gap between the output power of the channel at the longest wavelength in the first sub-band and the output power of the channel at the shortest wavelength in the second sub-band can be reduced.

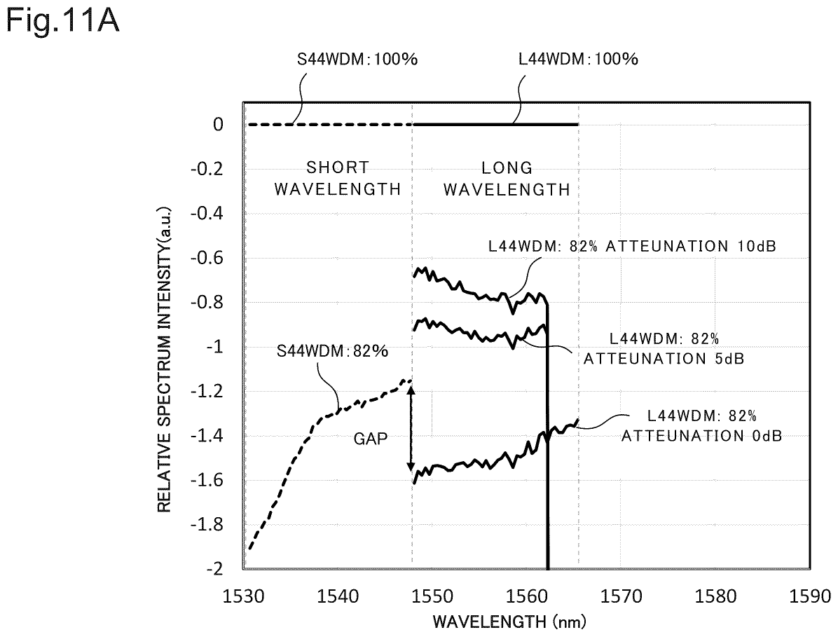

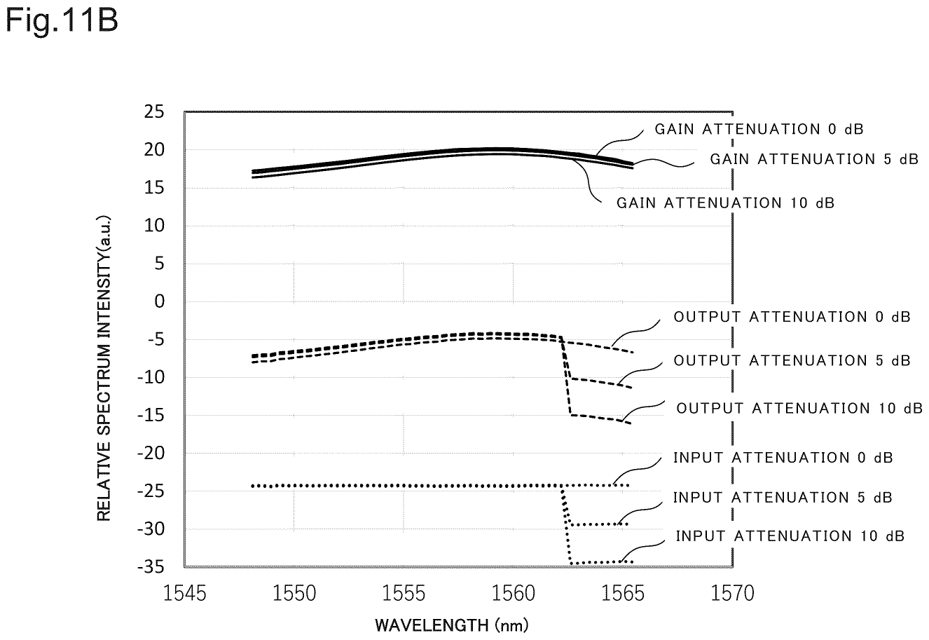

FIG. 11A is a graph for illustrating an amplification characteristic of an optical amplifier in the optical transmission system according to the fifth example embodiment of the present invention. The horizontal axis represents wavelength, and the vertical axis represents relative spectrum intensity. The optical transmission system is designed in such a way that a gap (GAP) does not occur between the output power of the channel at the longest wavelength in the first sub-band and the output power of the channel at the shortest wavelength in the second sub-band when the output of a pump light source in an optical amplification unit is 100%. When the output of the pump light source in the optical amplification unit decreases from 100% to 82%, a gap (GAP) of about 0.4 dB occurs between the output power of the channel at the longest wavelength in the first sub-band and the output power of the channel at the shortest wavelength in the second sub-band in the output waveform after passing an equalizer, as illustrated in FIG. 11A.

On the other hand, by the control of decreasing an amount of loading at wavelengths longer than those in the second sub-band according to the present example embodiment and specifically by the control of attenuating beams of dummy light at wavelengths longer than those in the second sub-band, the gap (GAP) is filled by control of attenuating eight wavelengths of dummy light in the case of the illustration in FIG. 11A.

FIG. 11B is a graph for illustrating an amplification characteristic of an optical amplifier in the optical transmission system according to the fifth example embodiment of the present invention. Attenuation applied to a loading wavelength at the terminal station 12A (the terminal station Tx on the transmission side) is output while maintaining a wavelength characteristic as-is. Therefore, in a plurality of serially connected repeaters 13, the same waveform as that input to an optical amplification unit in a repeater 13 in a first stage is launched into an optical amplification unit in a repeater 13 in the subsequent stage. Consequently, input signals to the plurality of serially connected repeaters 13 can be collectively controlled by performing the control of attenuating dummy light at the terminal station 12A (the terminal station Tx on the transmission side). In other words, optical amplification can be performed while each stage of the plurality of serially connected repeaters 13 filling the gap.

### Effects of Example Embodiment

The optical transmission system according to the present example embodiment and the method for controlling the system can reduce an energy loss caused by the equalization processing, by reduction in the gap in the amplification characteristic resulting from optical amplification for each separated sub-band, similarly to the example embodiments described above. As a result, an optical transmission system with improved energy utilization efficiency can be provided, and performance of the optical transmission system can be maintained.

Furthermore, the present example embodiment enables reduction in the gap in the output power by the control of decreasing an amount of loading at wavelengths longer than those in the second sub-band and specifically by the control of attenuating beams of dummy light at wavelengths longer than those in the second sub-band.

The control of an amount of loading according to the second to fourth example embodiments described above and the control of an amount of loading according to the fifth example embodiment can be used in parallel. For example, the control of shutting off beams of dummy light at wavelengths longer than those in the second sub-band as is the case in the second example embodiment and the control of attenuating beams of dummy light at wavelengths longer than those in the second sub-band as is the case in the present example embodiment can be used in parallel. The control of shutting off beams of dummy light at wavelengths longer than those in the second sub-band as is the case in the second example embodiment is related to coarse adjustment. In other words, the control of reducing an amount of loading at wavelengths longer than those in the second sub-band is related to coarse adjustment. The control of attenuating beams of dummy light at wavelengths longer than those in the second sub-band as is the case in the present example embodiment is related to fine adjustment.

With respect to adjustment of discrete amounts of gap (coarse adjustment) illustrated in FIG. 6, adjustment of an amount of gap in between (fine adjustment) can be performed by using the control of attenuating beams of dummy light at wavelengths longer than those in the second sub-band as is the case in the present example embodiment in parallel.

### Sixth Example Embodiment

Next, an optical transmission system according to a sixth example embodiment of the present invention and a method for controlling the system will be described. The present example embodiment is an example embodiment using the configuration of the optical transmission system illustrated in each of FIG. 2A and FIG. 3 described above, similarly to the second example embodiment to the fourth example embodiment, and is characterized by the operation of the optical transmission system and the method for controlling the optical transmission system. Assuming use of the configuration of the optical transmission system illustrated in each of FIG. 2A and FIG. 3 described above, description of the configuration is omitted in the present example embodiment.

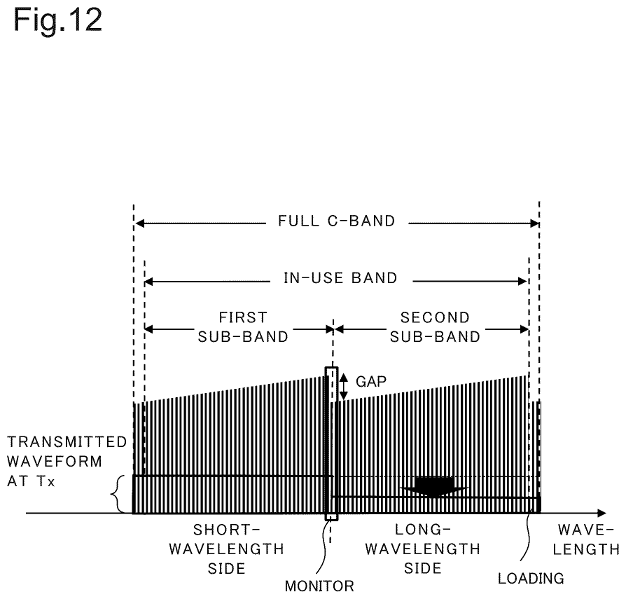

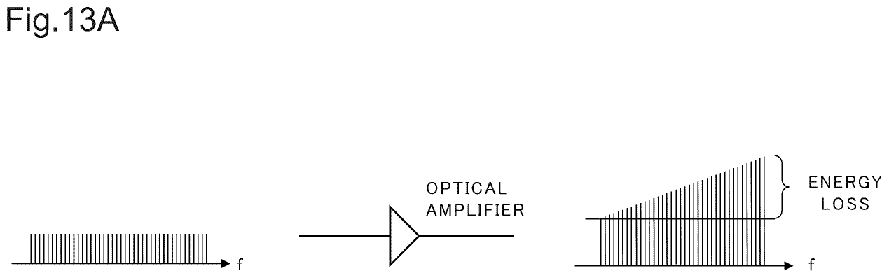

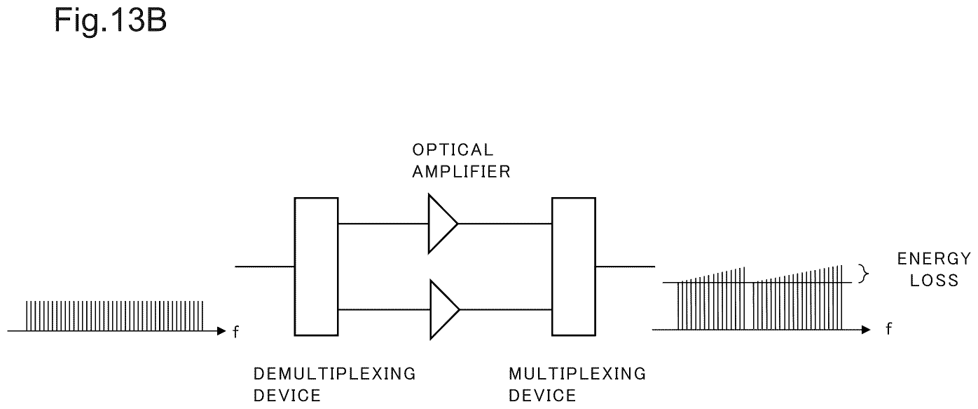

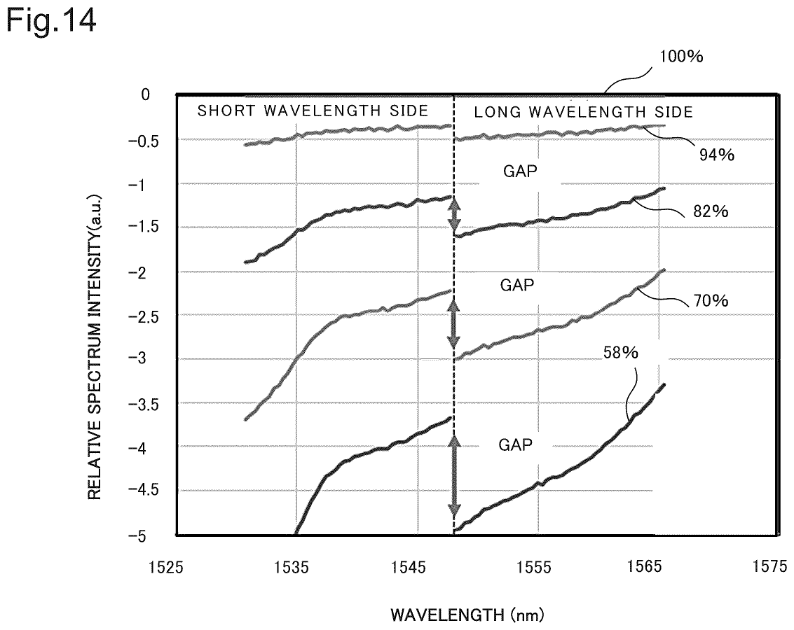

According to the present example embodiment, control of the transmitted waveform from a terminal station on the transmission side is also performed, similarly to the fifth example embodiment described above. FIG. 12 is a graph for illustrating the method for controlling the optical transmission system according to the sixth example embodiment of the present invention.

The output power of wavelength division multiplexed signal light and the output power of dummy light are increased for the full C-band at the terminal station 12A (the terminal station Tx on the transmission side) in the optical transmission system according to the present example embodiment, similarly to the fifth example embodiment. FIG. 12 illustrates a state in which dummy light is output in a band in the full C-band including wavelengths shorter than those in the first sub-band and dummy light is output in a band including wavelengths shorter than those in the second sub-band; and FIG. 12 illustrates a state in which the output power of dummy light is also increased.

The output power of a channel at the longest wavelength in the first sub-band on the relatively short-wavelength side is monitored, and the output power of a channel at the shortest wavelength in the second sub-band on the relatively long-wavelength side is also monitored in the optical transmission system according to the present example embodiment and the method for controlling the system, similarly to the example embodiments described above. Furthermore, a control signal is transmitted in such a way as to reduce a gap between the output power of the channel at the longest wavelength in the first sub-band and the output power of the channel at the shortest wavelength in the second sub-band.

The optical transmission system according to the present example embodiment and the method for controlling the system assumes control of changing an amount of loading as well as attenuating wavelength division multiplexed signal light in the second sub-band, as indicated by an arrow in FIG. 12. More specifically, in addition to the control of decreasing an amount of loading at wavelengths longer than those in the second sub-band as is the case in the fifth example embodiment, control of attenuating wavelength division multiplexed signal light in the second sub-band on the longer wavelength side as a whole included in wavelength division multiplexed signal light transmitted by the terminal station 12A (the terminal station Tx on the transmission side) is performed. By the control, an amount of amplification by an optical amplification unit for the second sub-band increases, and the gain of the optical amplification unit increases. Consequently, the output power of each beam of signal light in the wavelength division multiplexed signal light in the second sub-band increases, and the gap between the output power of the channel at the longest wavelength in the first sub-band and the output power of the channel at the shortest wavelength in the second sub-band can be reduced.

### Effects of Example Embodiment

The optical transmission system according to the present example embodiment and the method for controlling the system can reduce an energy loss caused by the equalization processing, by reduction in the gap in the amplification characteristic resulting from optical amplification for each separated sub-band, similarly to the example embodiments described above. As a result, an optical transmission system with improved energy utilization efficiency can be provided, and performance of the optical transmission system can be maintained.

Furthermore, the present example embodiment enables reduction in the gap in the output power by the control of decreasing an amount of loading at wavelengths longer than those in the second sub-band and specifically by the control of attenuating beams of dummy light at wavelengths longer than those in the second sub-band, similarly to the fifth example embodiment.

Furthermore, the control of attenuating wavelength division multiplexed signal light in the second sub-band on the longer wavelength side as a whole included in wavelength division multiplexed signal light transmitted by the terminal station 12A (the terminal station Tx on the transmission side) is performed, according to the present example embodiment. By control of not only adjusting an amount of loading at wavelengths longer than those in the second sub-band but also adjusting the input signal intensity in the second sub-band as a whole, an amount of amplification by the optical amplification unit for the second sub-band increases, and the gain of the optical amplification unit increases. As a result, the gap in the output power can be further reduced.

The control of an amount of loading according to the second to fourth example embodiments described above can also be used in parallel in the present example embodiment. For example, the control of shutting off beams of dummy light at wavelengths longer than those in the second sub-band as is the case in the second example embodiment and the control of attenuating wavelength division multiplexed signal light in the second sub-band as a whole as is the case in the present example embodiment can be used in parallel. With respect to adjustment of discrete amounts of gap (coarse adjustment) illustrated in FIG. 6, adjustment of an amount of gap in between (fine adjustment) can be performed by using the control of attenuating wavelength division multiplexed signal light in the second sub-band as a whole as is the case in the present example embodiment in parallel.

### Other Example Embodiments

While the preferred example embodiments of the present invention have been shown and described above, the present invention is not limited to these example embodiments. FIG. 5B is a graph for illustrating a modified example of the method for controlling the optical transmission system according to the second example embodiment of the present invention. For example, when it is confirmed in the second example embodiment described above that an amount of aging is larger in the second sub-band on the longer wavelength side among a plurality of sub-bands, a design of shifting the in-use band to the short-wavelength side of the full C-band from the start of operation of the optical transmission system and providing loading on the long-wavelength side may be considered. While loading is provided on the short-wavelength side of the first sub-band and is also provided on the long-wavelength side of the second sub-band in FIG. 5A, FIG. 5B differs in providing loading only on the long-wavelength side of the second sub-band. When it is confirmed that an amount of aging is greater in the second sub-band, control of providing loading only on the long-wavelength side of the second sub-band and gradually decreasing an amount of loading may be considered. When it is thus confirmed that an amount of aging is larger in the second sub-band on the long-wavelength side, an issue such as exhaustion of an amount of loading that can be decreased can be resolved by designing the in-use band to be shifted to the short-wavelength side of the full C-band. A margin for reducing the gap in the output power can be maintained in long-term operation.

Two or more single-core erbium-doped optical fiber amplifiers (SC-EDFAs) may be used in each of the plurality of optical amplification units 15₁ to 15ₘ in the repeater 13 described above. Further, one or more individual core pumping multi-core erbium-doped optical fiber amplifiers (MC-EDFAs) may be used in each of the plurality of optical amplification units 15₁ to 15ₘ in the repeater 13 described above. Further, one or more hybrid MC-EDFAs using collective clad pumping and individual core pumping in parallel may be used in the plurality of optical amplification units 15₁ to 15ₘ in the repeater 13 described above. Existing technologies may be applied to the present invention in terms of the two or more SC-EDFAs, the one or more individual core pumping MC-EDFAs, and the one or more hybrid MC-EDFAs using collective clad pumping and individual core pumping in parallel. For example, an optical amplifier using a plurality of single-core optical fibers is proposed in FIG. 8 in PTL 2 and the like. The structure of each of the plurality of single-core optical fibers includes a single core doped with rare-earth ions and a clad surrounding the single core. Further, an optical amplifier using a multicore optical fiber is proposed in FIG. 4 and FIG. 6 in PTL 2 and the like. The structure of the multicore optical fiber includes a plurality of cores doped with rare-earth ions and a clad surrounding the plurality of cores. It goes without saying that various modifications may be made within the spirit and scope of the invention as defined in the claims and such modifications are also included in the spirit and scope of the present invention.

The whole or part of the example embodiments disclosed above may also be described as, but not limited to, the following Supplementary Notes.

### Supplementary Note 1

An optical transmission system including: a pair of terminal stations transmitting and receiving wavelength division multiplexed (WDM) signal light to and from each other; an optical fiber propagating the wavelength division multiplexed signal light transmitted and received by the pair of terminal stations; and at least one repeater inserted into the optical fiber, wherein

the repeater includes an optical amplifier separating the wavelength division multiplexed signal light into a plurality of sub-bands including beams of signal light in a plurality of wavelength bands, amplifying the plurality of separated sub-bands by a plurality of related optical amplification units, and then multiplexing the plurality of amplified sub-bands,

the plurality of separated sub-bands include a first sub-band on a relatively short-wavelength side and a second sub-band on a relatively long-wavelength side, and

the optical transmission system further includes:
a monitoring unit monitoring output power of a channel at a longest wavelength in the first sub-band received by a terminal station on a reception side out of the pair of terminal stations and output power of a channel at a shortest wavelength in the second sub-band received by a terminal station on a reception side out of the pair of terminal stations; and
a control unit transmitting a control signal to a terminal station on a transmission side transmitting the wavelength division multiplexed signal light in such a way as to reduce a gap between output power of a channel at a longest wavelength in the first sub-band monitored by the monitoring unit and output power of a channel at a shortest wavelength in the second sub-band monitored by the monitoring unit.

### Supplementary Note 2

The optical transmission system according to Supplementary Note 1, wherein

the control signal instructs the terminal station on the transmission side to change an amount of loading.

### Supplementary Note 3

The optical transmission system according to Supplementary Note 2, wherein

the control signal instructs the terminal station on the transmission side to decrease an amount of loading at a wavelength longer than that in the second sub-band.

### Supplementary Note 4

The optical transmission system according to Supplementary Note 3, wherein

the control signal
instructs the terminal station on the transmission side to decrease an amount of loading at a wavelength longer than that in the second sub-band and,
when the gap is not sufficiently reduced by decreasing an amount of loading at the longer wavelength, further instructs the terminal station on the transmission side to increase an amount of loading at a wavelength shorter than that in the first sub-band.

### Supplementary Note 5

The optical transmission system according to Supplementary Note 2, wherein

the control signal instructs the terminal station on the transmission side to decrease power of dummy light at a wavelength longer than that in the second sub-band.

### Supplementary Note 6

The optical transmission system according to Supplementary Note 5, wherein

the control signal instructs the terminal station on the transmission side to decrease power of signal light in a wavelength band separated as the second sub-band.

### Supplementary Note 7

The optical transmission system according to Supplementary Note 2, wherein

the control signal instructs the terminal station on the transmission side to increase an amount of loading at a wavelength shorter than that in the first sub-band.

### Supplementary Note 8

The optical transmission system according to Supplementary Note 2, wherein

the control signal instructs the terminal station on the transmission side to change an amount of loading in a band between the first sub-band and the second sub-band.

### Supplementary Note 9

The optical transmission system according to any one of Supplementary Notes 2 to 8, wherein

the terminal station on the transmission side generates the wavelength division multiplexed signal light by wavelength division multiplexing signal light and dummy light, and

control of the amount of loading is performed by increasing or decreasing a channel of the dummy light at the terminal station on the transmission side.

### Supplementary Note 10

The optical transmission system according to Supplementary Note 3, wherein,

by shifting a channel at a shortest wavelength in the plurality of sub-bands to a short-wavelength side in an in-use band, a larger amount of loading at a wavelength longer than that in the second sub-band is secured.

### Supplementary Note 11

The optical transmission system according to any one of Supplementary Notes 1 to 10, wherein

each of the plurality of optical amplification units includes two or more single-core impurity-doped optical fiber amplifiers.

### Supplementary Note 12

The optical transmission system according to any one of Supplementary Notes 1 to 10, wherein

each of the plurality of optical amplification units includes one or more multicore impurity-doped optical fiber amplifiers.

### Supplementary Note 13

The optical transmission system according to any one of Supplementary Notes 1 to 10, wherein

each of the plurality of optical amplification units includes one or more hybrid multicore impurity-doped optical fiber amplifiers using collective clad pumping and individual core pumping in parallel.

### Supplementary Note 14

A method for controlling an optical transmission system including: a pair of terminal stations transmitting and receiving wavelength division multiplexed (WDM) signal light to and from each other; an optical fiber propagating the wavelength division multiplexed signal light transmitted and received by the pair of terminal stations; and at least one repeater inserted into the optical fiber, the method including,

by the repeater, separating the wavelength division multiplexed signal light into a plurality of sub-bands including beams of signal light in a plurality of wavelength bands, amplifying the plurality of separated sub-bands by a plurality of related optical amplification units, and then multiplexing the plurality of amplified sub-bands, wherein

the plurality of separated sub-bands include a first sub-band on a relatively short-wavelength side and a second sub-band on a relatively long-wavelength side, and

the method further includes:
monitoring output power of a channel at a longest wavelength in the first sub-band and output power of a channel at a shortest wavelength in the second sub-band that are received by a terminal station on a reception side out of the pair of terminal stations; and
transmitting a control signal to a terminal station on a transmission side transmitting the wavelength division multiplexed signal light in such a way as to reduce a gap between output power of a channel at a longest wavelength in the first sub-band and output power of a channel at a shortest wavelength in the second sub-band.

### Supplementary Note 15

The method for controlling an optical transmission system according to Supplementary Note 14, wherein

the control signal instructs the terminal station on the transmission side to change an amount of loading.

### Supplementary Note 16

The method for controlling an optical transmission system according to Supplementary Note 15, wherein

the control signal instructs the terminal station on the transmission side to decrease an amount of loading at a wavelength longer than that in the second sub-band.

### Supplementary Note 17

The method for controlling an optical transmission system according to Supplementary Note 16, wherein

the control signal
instructs the terminal station on the transmission side to decrease an amount of loading at a wavelength longer than that in the second sub-band and,
when the gap is not sufficiently reduced by decreasing an amount of loading at the longer wavelength, further instructs the terminal station on the transmission side to increase an amount of loading at a wavelength shorter than that in the first sub-band.

### Supplementary Note 18

The method for controlling an optical transmission system according to Supplementary Note 15, wherein

the control signal instructs the terminal station on the transmission side to decrease power of dummy light at a wavelength longer than that in the second sub-band.

### Supplementary Note 19

The method for controlling an optical transmission system according to Supplementary Note 18, wherein

the control signal instructs the terminal station on the transmission side to decrease power of signal light in a wavelength band separated as the second sub-band.

### Supplementary Note 20

The method for controlling an optical transmission system according to Supplementary Note 15, wherein

the control signal instructs the terminal station on the transmission side to increase an amount of loading at a wavelength shorter than that in the first sub-band.

### Supplementary Note 21

The method for controlling an optical transmission system according to Supplementary Note 15, wherein

the control signal instructs the terminal station on the transmission side to change an amount of loading in a band between the first sub-band and the second sub-band.

### Supplementary Note 22

The method for controlling an optical transmission system according to any one of Supplementary Notes 15 to 21, wherein

the terminal station on the transmission side generates the wavelength division multiplexed signal light by wavelength division multiplexing signal light and dummy light, and

control of the amount of loading is performed by increasing or decreasing a channel of the dummy light at the terminal station on the transmission side.

### Supplementary Note 23

The method for controlling an optical transmission system according to Supplementary Note 16, wherein,

by shifting a channel at a shortest wavelength in the plurality of sub-bands to a short-wavelength side in an in-use band, a larger amount of loading at a wavelength longer than that in the second sub-band is secured.

### Reference Signs List

11 Optical fiber
12A, 12B, 102A, 102B Terminal station
13, 103 Repeater
14, 104 Demultiplexer
15₁ to 15ₘ, 105₁ to 105ₘ Optical amplification unit
16, 106 Multiplexer
121, 121, 123 Multiplexing unit
124 Multiplexing means
125 Demultiplexing means
126, 127, 128 Demultiplexing unit
21 Output gap monitor
22 Loading control device
30 Network management system
108 Monitoring unit
109 Control unit

What is claimed is:

1. An optical transmission system comprising:
a pair of terminal stations transmitting and receiving wavelength division multiplexed (WDM) signal light to and from each other;
an optical fiber propagating the wavelength division multiplexed signal light transmitted and received by the pair of terminal stations; and
at least one repeater relaying the optical fiber, wherein
the repeater includes an optical amplifier separating the wavelength division multiplexed signal light into a plurality of sub-bands including beams of signal light in a plurality of wavelength bands, amplifying the plurality of separated sub-bands by a plurality of related optical amplification units, and then multiplexing the plurality of amplified sub-bands,
the plurality of separated sub-bands include a first sub-band on a relatively short-wavelength side and a second sub-band on a relatively long-wavelength side, and
the optical transmission system further comprises:
monitor monitoring output power of a channel at a longest wavelength in the first sub-band received by a terminal station on a reception side out of the pair of terminal stations and output power of a channel at a shortest wavelength in the second sub-band received by a terminal station on a reception side out of the pair of terminal stations; and
a controller transmitting a control signal to a terminal station on a transmission side transmitting the wavelength division multiplexed signal light in such a way as to reduce a gap between output power of a channel at a longest wavelength in the first sub-band monitored by the monitoring unit and output power of a channel at a shortest wavelength in the second sub-band monitored by the monitoring unit.

2. The optical transmission system according to claim 1, wherein
the control signal instructs the terminal station on the transmission side to change an amount of loading.

3. The optical transmission system according to claim 2, wherein
the control signal instructs the terminal station on the transmission side to decrease an amount of loading at a wavelength longer than that in the second sub-band.

4. The optical transmission system according to claim 3, wherein
the control signal
further instructs the terminal station on the transmission side to increase an amount of loading at a wavelength shorter than that in the first sub-band.

5. The optical transmission system according to claim 2, wherein
the control signal instructs the terminal station on the transmission side to decrease power of dummy light at a wavelength longer than that in the second sub-band.

6. The optical transmission system according to claim 5, wherein
the control signal instructs the terminal station on the transmission side to decrease power of signal light in a wavelength band separated as the second sub-band.

7. The optical transmission system according to claim 2, wherein
the control signal instructs the terminal station on the transmission side to increase an amount of loading at a wavelength shorter than that in the first sub-band.

8. The optical transmission system according to claim 2, wherein
the control signal instructs the terminal station on the transmission side to change an amount of loading in a band between the first sub-band and the second sub-band.

9. The optical transmission system according to claim 2, wherein
the terminal station on the transmission side generates the wavelength division multiplexed signal light by wavelength division multiplexing signal light and dummy light, and
control of the amount of loading is performed by increasing or decreasing a channel of the dummy light at the terminal station on the transmission side.

10. The optical transmission system according to claim 3, wherein,
by shifting a channel at a shortest wavelength in the plurality of sub-bands to a short-wavelength side in an in-use band, a larger amount of loading at a wavelength longer than that in the second sub-band is secured.

11. The optical transmission system according to claim 1, wherein
each of the plurality of optical amplification units includes two or more single-core impurity-doped optical fiber amplifiers.

12. The optical transmission system according to claim 1, wherein
each of the plurality of optical amplification units includes one or more multicore impurity-doped optical fiber amplifiers.

13. The optical transmission system according to claim 1, wherein
each of the plurality of optical amplification units includes one or more hybrid multicore impurity-doped optical fiber amplifiers using collective clad pumping and individual core pumping in parallel.

14. A method for controlling an optical transmission system including: a pair of terminal stations transmitting and receiving wavelength division multiplexed (WDM) signal light to and from each other; an optical fiber propagating the wavelength division multiplexed signal light transmitted and received by the pair of terminal stations; and at least one repeater inserted into the optical fiber, the method comprising,
by the repeater, separating the wavelength division multiplexed signal light into a plurality of sub-bands including beams of signal light in a plurality of wavelength bands, amplifying the plurality of separated sub-bands by a plurality of related optical amplification units, and then multiplexing the plurality of amplified sub-bands, wherein
the plurality of separated sub-bands include a first sub-band on a relatively short-wavelength side and a second sub-band on a relatively long-wavelength side, and
the method further comprises:
monitoring output power of a channel at a longest wavelength in the first sub-band and output power of a channel at a shortest wavelength in the second sub-band that are received by a terminal station on a reception side out of the pair of terminal stations; and
transmitting a control signal to a terminal station on a transmission side transmitting the wavelength division multiplexed signal light in such a way as to reduce a gap between output power of a channel at a longest wavelength in the first sub-band and output power of a channel at a shortest wavelength in the second sub-band.

15. The method for controlling an optical transmission system according to claim 14, wherein
the control signal instructs the terminal station on the transmission side to change an amount of loading.

16. The method for controlling an optical transmission system according to claim 15, wherein
the control signal instructs the terminal station on the transmission side to decrease an amount of loading at a wavelength longer than that in the second sub-band.

17. The method for controlling an optical transmission system according to claim 16, wherein
the control signal
further instructs the terminal station on the transmission side to increase an amount of loading at a wavelength shorter than that in the first sub-band.

18. The method for controlling an optical transmission system according to claim 15, wherein
the control signal instructs the terminal station on the transmission side to decrease power of dummy light at a wavelength longer than that in the second sub-band.

19. The method for controlling an optical transmission system according to claim 18, wherein
the control signal instructs the terminal station on the transmission side to decrease power of signal light in a wavelength band separated as the second sub-band.

20. The method for controlling an optical transmission system according to claim 15, wherein
the control signal instructs the terminal station on the transmission side to increase an amount of loading at a wavelength shorter than that in the first sub-band.

21-23. (canceled)
